(19) United States
(12) Patent Application Publication
(10) Pub. No.: US 2025/0079707 A1
(43) Pub. Date: Mar. 6, 2025

(54) ANTENNA AND ELECTRONIC APPARATUS

(71) Applicant: SONY GROUP CORPORATION, TOKYO (JP)

(72) Inventors: YUKIO KANEKO, TOKYO (JP); TAKASHI KAWAMURA, TOKYO (JP); NOBUYUKI MORI, TOKYO (JP)

(21) Appl. No.: 18/706,847

(22) PCT Filed: Sep. 16, 2022
(86) PCT No.: PCT/JP2022/034706

§ 371 Date: May 2, 2024

(30) Foreign Application Priority Data
Nov. 10, 2021 (JP) 2021-183074

(51) Int. Cl. H01Q 7/00; H01Q 1/22; H01Q 23/00

(52) U.S. Cl. CPC H01Q 7/00; H01Q 1/22; H01Q 23/00

(57) ABSTRACT

An antenna according to an embodiment of the present technology includes a loop-shaped conductor and a structure. The loop-shaped conductor is configured in a loop shape surrounding a first direction and has a gap configured using a predetermined second direction orthogonal to the first direction as a reference. The structure is electrically connected to the loop-shaped conductor and arranged orthogonally to the second direction. Accordingly, it is possible to achieve a reduction of a distance from the human body and a reduction of a clearance from a metal part, and it is very advantageous for downsizing the electronic apparatus. Moreover, it is possible to exhibit high communication performance.

### TECHNICAL FIELD

The present technology relates to an antenna and an electronic apparatus including the antenna.

### BACKGROUND ART

Patent Literature 1 has disclosed an antenna capable of receiving circularly polarized waves and performing impedance matching between the antenna and an integrated circuit (IC) of a semiconductor device, and a semiconductor device having such an antenna.

### CITATION LIST

### Patent Literature

Patent Literature 1: Japanese Patent No. 4944745

### DISCLOSURE OF INVENTION

### Technical Problem

It is desirable to provide a technology capable of achieving downsizing and a performance improvement of an antenna.

In view of the above-mentioned circumstances, it is an objective of the present technology to provide an antenna and an electronic apparatus capable of achieving downsizing and a performance improvement.

### Solution to Problem

In order to accomplish the above-mentioned objective, an antenna according to an embodiment of the present technology includes a loop-shaped conductor and a structure.

The loop-shaped conductor is configured in a loop shape surrounding a first direction and has a gap configured using a predetermined second direction orthogonal to the first direction as a reference.

The structure is electrically connected to the loop-shaped conductor and arranged orthogonally to the second direction.

In this antenna, the loop-shaped conductor having the loop-shaped configuration surrounding the first direction and having the gap configured using the second direction as the reference is used. Moreover, the structure is arranged to the loop-shaped conductor orthogonally to the second direction. Accordingly, downsizing and a performance improvement can be achieved.

The first direction may be set as a direction of a magnetic current source generated by the loop-shaped conductor. In this case, the gap may be configured such that the second direction is a direction of an electric current source generated by the loop-shaped conductor.

The loop-shaped conductor may have a first edge portion and the second edge portion that are opposite to each other along the second direction and constitute the gap.

A length of the loop-shaped conductor may be equal to or smaller than ½ of a maximum wavelength of electromagnetic waves included in a frequency bandwidth used for wireless communication using the antenna.

The frequency bandwidth used for the communication may be a frequency bandwidth of from 2.40 GHz to 2.48 GHz.

The antenna may be configured such that the second direction is along a direction perpendicular to the object when the antenna is installed with respect to an object constituted by a conductor or a lossy dielectric.

The antenna may include a flexible printed circuit (FPC) on which the loop-shaped conductor is formed.

The antenna may be configured to be arranged inside a casing. In this case, the loop-shaped conductor may be configured inside the casing by laser direct structuring (LDS).

The structure may have a flat-plate shape including a main surface, the main surface being arranged orthogonally to the second direction.

The structure may be a circuit board or a system in package (SiP).

The antenna may further include: a communication circuit unit; a first wiring portion; and a second wiring portion.

The communication circuit unit controls wireless communication by the antenna.

The first wiring portion electrically connects the structure and the loop-shaped conductor to each other.

The second wiring portion electrically connects the communication circuit unit and the loop-shaped conductor to each other.

The communication circuit unit may be configured in the structure.

A first radiation pattern by a magnetic current source along the first direction and a second radiation pattern by an electric current source along the second direction may be configured as radiation patterns of electromagnetic waves on a plane including the first direction and the second direction.

An electronic apparatus according to an embodiment of the present technology includes the above-mentioned antenna.

The electronic apparatus may be configured as a true wireless stereo.

The electronic apparatus may be configured to be worn on a human ear and may be configured such that the second direction is along a direction perpendicular to an external acoustic pore when the electronic apparatus is worn on the ear.

The electronic apparatus may be configured to be worn on a human ear. In this case, the gap may be configured in a portion of the loop-shaped conductor which is adjacent to an auricle when the electronic apparatus is worn on the ear.

The electronic apparatus may be further include a part arranged in a space on an inner peripheral side of the loop-shaped conductor.

The part may include a magnetic material.

### BRIEF DESCRIPTION OF DRAWINGS

FIG. 1 A schematic view for describing an overview of a TWS according to an embodiment of the present technology.

FIG. 2 A schematic view for describing electromagnetic wave radiation by a dipole antenna and a loop antenna.

FIG. 3 A diagram for describing consideration contents regarding a case where a human body or metal has approached the dipole antenna and the loop antenna.

FIG. 4 A schematic view for describing electromagnetic wave radiation by a normal mode helical antenna.

FIG. 5 A diagram for describing consideration contents regarding a case where a copper foil has approached an NMHA.

FIG. 6 A graph for describing a maximum gain in a case where the copper foil has approached the NMHA.

FIG. 7 A schematic view showing a configuration example of an antenna according to the present embodiment.

FIG. 8 A schematic view showing a specific configuration example of a structure.

FIG. 9 A side view as the antenna is viewed from the left side along a Z-axis direction.

FIG. 10 A graph showing a radiation pattern (radiation directivity) of electromagnetic waves of the antenna according to the present embodiment.

FIG. 11 A view for describing a simulation results regarding a case where the copper foil has approached the antenna according to the present embodiment.

FIG. 12 A graph describing a maximum gain in a case where the copper foil has approached the antenna according to the present embodiment.

FIG. 13 A view for describing assembling with other parts.

FIG. 14 A schematic view showing an orientation of the antenna 8 in the TWS.

FIG. 15 A schematic view showing the orientation of the antenna 8 in the TWS (when it is worn on the ear).

FIG. 16 A schematic view showing a variation example of a loop-shaped conductor, a first wiring portion, and a second wiring portion.

FIG. 17 A schematic view showing a variation example of the loop-shaped conductor, the first wiring portion, and the second wiring portion.

FIG. 18 A schematic view showing a variation example of the loop-shaped conductor, the first wiring portion, and the second wiring portion.

FIG. 19 A schematic view showing a variation example of the loop-shaped conductor, the first wiring portion, and the second wiring portion.

FIG. 20 A schematic view showing a variation example of the loop-shaped conductor, the first wiring portion, and the second wiring portion.

FIG. 21 A schematic view showing a configuration example of the antenna in a case where an FPC is used.

FIG. 22 A schematic view showing an example in a case where the loop-shaped conductor is configured by LDS.

FIG. 23 A schematic view for describing other application examples of the present technology.

### MODE(S) FOR CARRYING OUT THE INVENTION

Hereinafter, embodiments according to the present technology will be described with reference to the drawings.

### True Wireless Stereo (TWS)

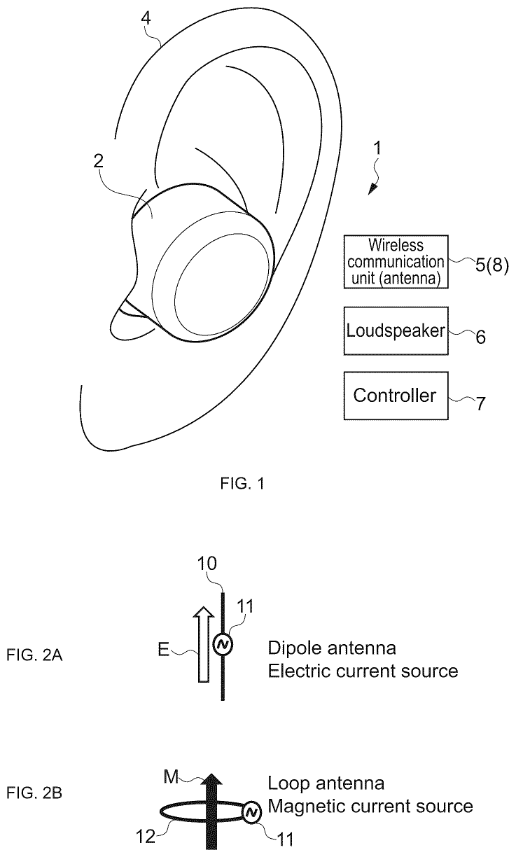

FIG. 1 is a schematic view for describing an overview of a TWS according to an embodiment of the present technology.

FIG. 1 schematically shows some of functional configurations of the TWS as a block diagram. The TWS is also called “left and right independent earphones” or “full wireless stereo)”.

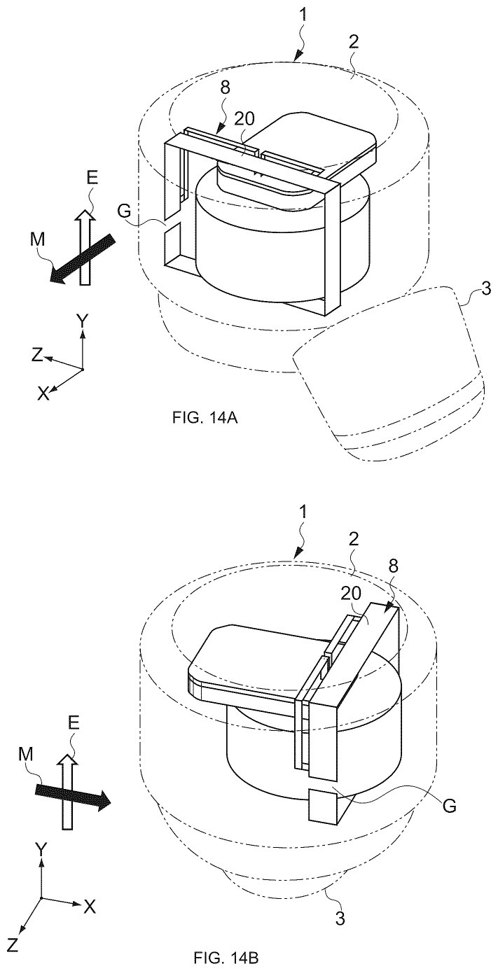

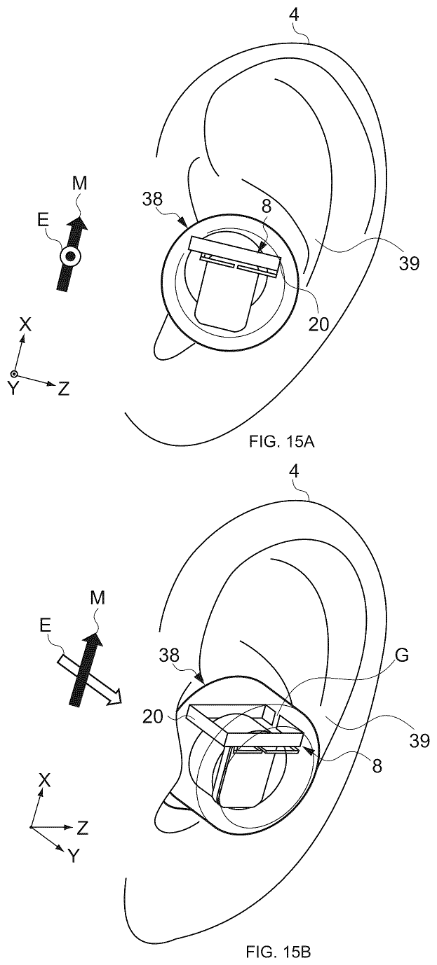

As shown in FIG. 1, TWS 1 includes a casing portion 2 and an ear piece 3 (see FIG. 14) and is configured to be worn on a human ear 4.

The TWS 1 can be worn on the ear 4 by inserting the ear piece 3 into an external acoustic pore of the ear 4. FIG. 1 shows the TWS 1 for the left ear worn on the left ear. Wearing the TWS 1 for the right ear on the right ear enables stereo mode sounds to be heard by both left and right ears. As a matter of course, the TWS 1 may be worn on only one ear.

The TWS 1 is connected to be capable of communicating with the external apparatus by wireless communication. The TWS 1 is capable of receiving and reproducing audio data from an external apparatus via the wireless communication.

For example, wireless LAN communication such as WiFi or near-field communication such as Bluetooth (registered trademark) can be used as the wireless communication.

The external apparatus can be any device such as a smartphone, a tablet terminal, or a personal computer (PC). Moreover, a server apparatus or the like on a network may be connected to be capable of communicating with the TWS 1 as the external apparatus.

As shown in FIG. 1, the TWS 1 includes, as functional configurations, a wireless communication unit 5, a loudspeaker 6, and a controller 7. Each block is configured inside the casing portion 2.

The wireless communication unit 5 is a module for wireless communication with other devices. For example, a wireless LAN module such as WiFi or a communication module such as Bluetooth (registered trademark) is used.

As shown in FIG. 1, an antenna 8 according to the present technology is configured inside the wireless communication unit 5. The antenna 8 will be described later in detail.

The loudspeaker 6 is capable of outputting sounds. Its specific configuration of the loudspeaker 6 is not limited, and any configuration may be employed.

The controller 7 controls the operation of each component of the TWS 1. The controller 7 has a hardware circuit necessary for a computer, for example, a CPU and memories (RAM and ROM). Various types of processing are executed by the CPU loading and executing a control program stored in a memory to the RAM.

The controller 7 may be, for example, a programmable logic device (PLD) such as a field programmable gate array (FPGA) or another device such as application specific integrated circuit (ASIC).

In the present embodiment, an information processing method according to the present embodiment is executed by the CPU of the controller 7 executing a program according to the present embodiment. For example, a wireless communication control method and an audio reproduction method are executed as the information processing method.

In a case where the wireless communication is performed with the external apparatus, the controller 7 drives the wireless communication unit 5.

For sending data (information) to the external apparatus, the antenna 8 of the wireless communication unit 5 is provided with electrical signals according to the data and electromagnetic waves (radio waves) are radiated as wireless signals.

For receiving data from the external apparatus, the antenna 8 receives electromagnetic waves radiated from the external apparatus as wireless signals and electrical signals are output. The data is acquired on the basis of the output electrical signals.

As described above, in the present embodiment, the wireless communication unit 5 is capable of receiving audio data from the external apparatus. The controller 7 is capable of reproducing the received audio data by driving the loudspeaker 6.

It should be noted that specific communication scheme, algorithm, and the like for achieving the wireless communication are not limited, and any communication scheme and algorithm may be used.

### Consideration Contents Regarding Antenna 8

For the sake of easy understanding of the antenna 8 according to the present embodiment, first of all, the consideration contents of the inventors of the present technology will be briefly described with reference to FIGS. 2 to 6.

A dipole antenna 10 as schematically shown in A of FIG. 2 will be considered. In A of FIG. 2, the dipole antenna 10 is configured to extend along upper and lower directions in the figure.

The dipole antenna 10 is supplied with AC power from an AC power source 11. It should be noted that the AC power source 11 may be an electric power source with internal impedance and its specific configuration, its connection form with the dipole antenna 10, and the like may be arbitrarily designed.

In FIG. 2 and other figures, the depiction of the AC power source 11 schematically shows that AC power is supplied using the position where the AC power source 11 is depicted as a power supply point.

When the dipole antenna 10 is supplied with AC power, high-frequency AC current flows into the dipole antenna 10 and electromagnetic waves are radiated. That is, an electric current source E is configured along an extending direction of the dipole antenna 10 and electromagnetic waves are radiated from the electric current source.

In the example shown in A of FIG. 2, the extending direction of the dipole antenna 10 (upper and lower directions in the figure) are a direction of the electric current source E.

Moreover, the dipole antenna 10 receives a change in the electric field in the extending direction of the dipole antenna 10, i.e., the direction of the electric current source E at high sensitivity. Thus, it is possible to receive electromagnetic waves with the extending direction of the dipole antenna 10 as a polarization direction (direction of the electric field) at high sensitivity.

A loop antenna 12 as schematically shown in B of FIG. 2 will be considered. In B of FIG. 2, the loop antenna 12 is configured such that the upper and lower directions in the figure are a center axis direction.

The loop antenna 12 is supplied with AC power from the AC power source 11. Accordingly, a magnetic field is generated along the center axis direction of the loop antenna 12 and the orientation of the magnetic field changes at a high frequency. Due to the change in the magnetic field, electromagnetic waves are radiated. That is, a magnetic current source M is configured along the center axis direction of the loop antenna 12 and electromagnetic waves are radiated by the magnetic current source M.

In the example shown in B of FIG. 2, the center axis direction of the loop antenna 12 (upper and lower directions in the figure) is a direction of the magnetic current source M.

Further, the loop antenna 12 receives a change in the magnetic field in the center axis direction of the loop antenna 12, i.e., the direction of the magnetic current source M at high sensitivity. Thus, it is possible to receive electromagnetic waves with a direction (left and right directions in the figure) orthogonal to the center axis direction of the loop antenna 12 as a polarization direction (direction of the electric field) at high sensitivity.

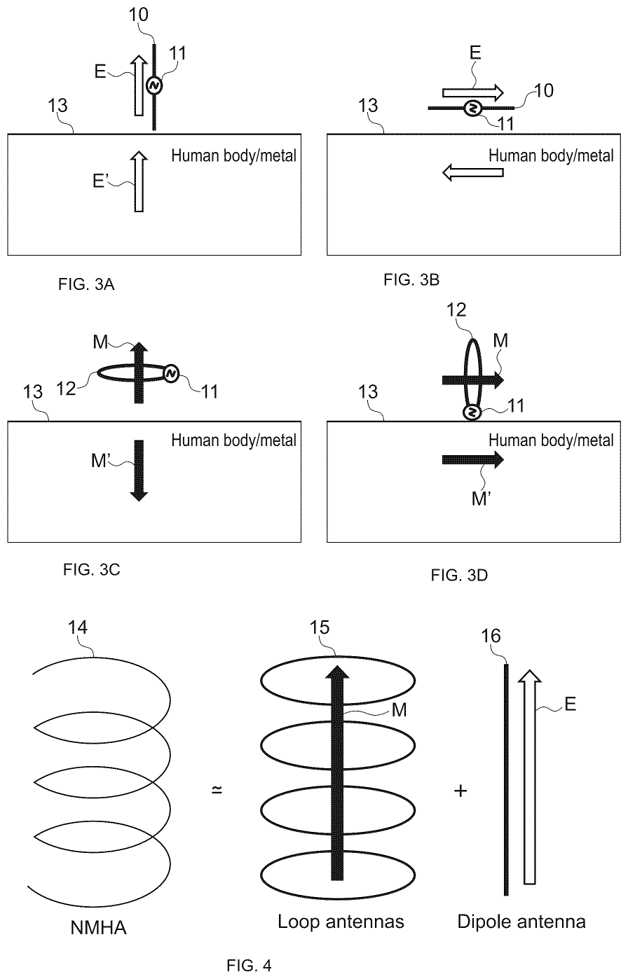

FIG. 3 is a diagram for describing consideration contents regarding a case where a human body or metal has approached the dipole antenna 10 and the loop antenna 12. Hereinafter, the human body or metal will be collectively referred to as a human body/metal 13.

As shown in A of FIG. 3, the dipole antenna 10 is installed perpendicularly to the human body/metal 13. In this case, when the dipole antenna 10 is supplied with electric power, the electric current source E is configured along the extending direction of the dipole antenna 10 and a mirror image of the electric current source is generated inside the human body/metal 13. This mirror image component E′ is generated in the same direction and the same orientation as the electric current source E. Thus, the electric current source E and the mirror image component E′ enhance each other, and therefore it is possible to execute the wireless communication (transmission and reception) by strong electromagnetic waves (wireless signals).

As shown in B of FIG. 3, the dipole antenna 10 is installed in parallel with the human body/metal 13. In this case, when the dipole antenna 10 is supplied with electric power, the electric current source E is configured along the extending direction of the dipole antenna 10 and the mirror image of the electric current source E is generated inside the human body/metal 13. This mirror image component E′ is generated in the same direction as the electric current source E and an opposite orientation. Thus, the electric current source E and the mirror image component E′ weaken each other, and therefore electromagnetic waves (wireless signals) are weakened, and it adversely affects the wireless communication (transmission and reception).

As shown in C of FIG. 3, the loop antenna 12 is installed such that the center axis direction is perpendicular to the human body/metal 13. In this case, when the loop antenna 12 is supplied with electric power, the magnetic current source M is configured along the center axis of the loop antenna 12 and the mirror image of the magnetic current source M is generated inside the human body/metal 13. This mirror image component M′ is generated in the same direction as the magnetic current source M and an opposite orientation. Thus, the magnetic current source M and the mirror image component M′ weaken each other, and therefore electromagnetic waves (wireless signals) are weakened, and it adversely affects the wireless communication (transmission and reception).

As shown in D of FIG. 3, the loop antenna 12 is installed such that the center axis direction is parallel to the human body/metal 13. In this case, when the loop antenna 12 is supplied with electric power, the magnetic current source M is configured along the center axis of the loop antenna 12 and the mirror image of the magnetic current source M is generated inside the human body/metal 13. This mirror image component M′ is generated in the same direction and the same orientation as the magnetic current source M. Thus, the magnetic current source M and the mirror image component M′ enhance each other, and therefore it is possible to execute the wireless communication (transmission and reception) by strong electromagnetic waves (wireless signals).

It should be noted that in the present disclosure, the metal is included in a conductor and the human body is included in a lossy dielectric. With respect to any conductor other than the metal and any lossy dielectric other than the human body, matters described above with reference to FIG. 3 are established.

A normal mode helical antenna (NMHA) as schematically shown in FIG. 4 will be considered.

As shown in FIG. 4, an NMHA 14 has a coil-like structure wound about the center axis plural times. In order to discuss radiation characteristics of electromagnetic waves, the NMHA 14 can be considered as a configuration combining a plurality of loop antennas 15 arranged along the center axis direction and a dipole antenna 16 extending in the center axis direction.

That is, the NMHA 14 can be considered as an antenna capable of radiating electromagnetic waves from the magnetic current source M constituted by the plurality of loop antennas 15 and the electric current source E constituted by the dipole antenna 16.

It should be noted that the direction of the magnetic current source M and the direction of the electric current source E are both the center axis direction (upper and lower directions in the figure).

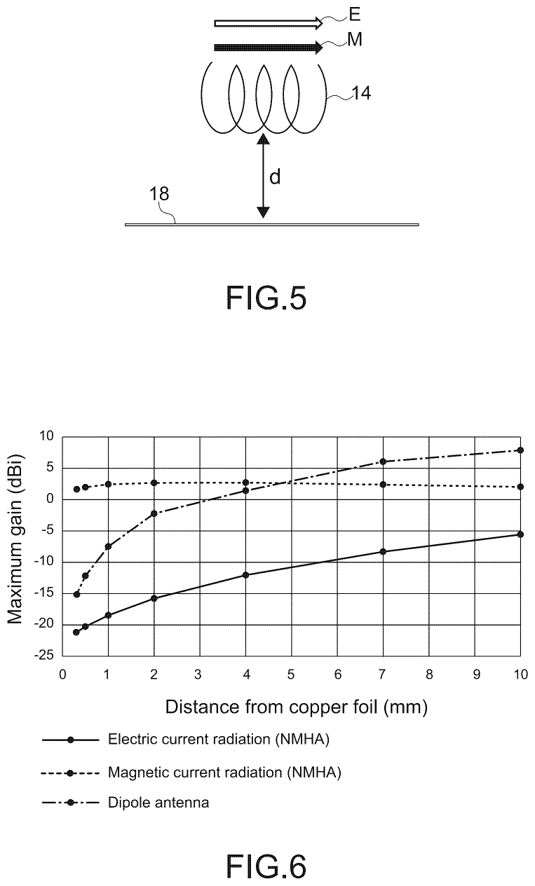

FIGS. 5 and 6 are diagrams for describing consideration contents regarding a case where a copper foil has approached the NMHA 14.

As shown in FIG. 5, the NMHA 14 is installed such that the center axis direction is parallel to a copper foil 18. Moreover, a maximum gain is calculated by simulation while varying a distance d between the copper foil 18 and the NMHA 14.

FIG. 6 plots a maximum gain of electric current radiation (radiation by the electric current source E) of the NMHA 14 and a maximum gain of the magnetic current radiation (radiation by the magnetic current source M) in a case where the distance d is reduced from 10 mm.

The electric current source E and the magnetic current source M configured by the NMHA 14 are respectively configured in a direction parallel to the copper foil 18. That is, a relation between the electric current source E and the copper foil 18 is similar to that shown in B of FIG. 3. Moreover, a relation between the magnetic current source M and the copper foil 18 is similar to that shown in D of FIG. 3.

Therefore, as shown in FIG. 6, the maximum gain of the electric current radiation decreases as the NMHA 14 is made to approach the copper foil. Meanwhile, the maximum gain of the magnetic current radiation is maintained without decreasing (it increases depending on the distance d).

It should be noted that FIG. 6 also plots the maximum gain in a case where the dipole antenna is arranged in parallel with the copper foil 18 and is made to approach the copper foil 18. That is, the maximum gain in a case where the dipole antenna 10 is made to approach the copper foil 18 in the state shown in B of FIG. 3 is plotted.

As shown in FIG. 6, the maximum gain decreases as the dipole antenna is made to approach the copper foil. This corresponds to a decrease in the maximum gain of the electric current radiation when the NMHA 14 is made to approach the copper foil.

The NMHA 14 is installed such that the center axis direction is perpendicular to the copper foil 18. In this case, the relation between the electric current source E and the copper foil 18 is similar to that shown in A of FIG. 3. Moreover, the relation between the magnetic current source M and the copper foil 18 is similar to that shown in C of FIG. 3.

Although the graph is omitted, the maximum gain of the magnetic current radiation decreases as the NMHA 14 is made to approach the copper foil. Meanwhile, the maximum gain of the electric current radiation is maintained without decreasing.

That is, in the NMHA 14, the direction of the electric current source E and the direction of the magnetic current source M are the same direction, and therefore either the electric current source E (electric current radiation) or the magnetic current source M (magnetic current radiation) is weakened by approaching the human body or metal, and it adversely affects the wireless communication.

### Antenna According to Present Technology

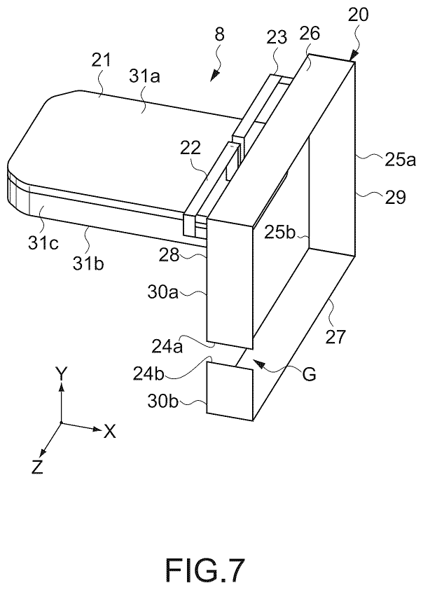

FIG. 7 is a schematic view showing a configuration example of the antenna 8 according to the present embodiment.

The antenna 8 includes a loop-shaped conductor 20, a structure 21, a first wiring portion 22, and a second wiring portion 23.

The loop-shaped conductor 20 is configured in a loop shape surrounding a predetermined direction. Typically, the loop-shaped conductor 20 is configured in a loop shape with the predetermined direction as a center axis direction. Hereinafter, it is assumed that the center axis direction of the loop-shaped conductor 20 is an X-axis direction.

As shown in FIG. 7, in the present embodiment, a conductor having an elongated flat-plate shape with two short sides (a first short side 24a and a second short side 24b) and two long sides (a first long side 25a and a second long side 25b) is used. The conductor is arranged such that the short side direction and the center axis direction (X-axis direction) of the conductor are parallel to each other. Then, the conductor is configured in a loop shape by being folded with the X-axis direction as a center. Accordingly, the loop-shaped conductor 20 is configured.

Hereinafter, the upper and lower directions in the figure are a Y-axis direction orthogonal to the X-axis direction. Moreover, it is assumed that a direction orthogonal to each of the X-axis direction and the Y-axis direction is a Z-axis direction.

Moreover, the description will be given assuming that the X-axis direction is a depth direction (a positive side of the arrow is a front side and a negative side of the arrow is a deep side), the Y-axis direction is upper and lower directions (a positive side of the arrow is an upper side and a negative side of the arrow is a lower side), and the Z-axis direction is left and right directions (a positive side of the arrow is a left side and a negative side of the arrow is a right side).

As a matter of course, the orientation in which the antenna 8 is used is not limited.

As the loop-shaped conductor 20 is viewed along the X-axis direction, the loop-shaped conductor 20 is folded in a substantially square shape. Assuming that a plane (virtual plane) configured on an inner peripheral side of the loop-shaped conductor 20 and orthogonal to the X-axis direction is a loop plane, the shape of the loop plane is substantially square.

As the loop-shaped conductor 20 is viewed along the X-axis direction, the loop-shaped conductor 20 is constituted by an upper portion 26, a lower side portion 27, a left side portion 28, and a right side portion 29.

As shown in FIG. 7, the left side portion 28 of the loop-shaped conductor 20 is constituted by the first short side 24a, the second short side 24b, an upper portion 30a from the first short side 24a to the upper portion 26, and a lower portion 30b from the second short side 24b to the lower side portion 27.

As shown in FIG. 7, the loop-shaped conductor 20 is configured to have a gap G.

In the present embodiment, the first short side 24a and the second short side 24b of the loop-shaped conductor 20 are arranged with a predetermined interval (gap G) at positions opposite to each other. That is, the first short side 24a and the second short side 24b opposite to each other constitute the gap G.

The gap G is configured using the predetermined direction orthogonal to the center axis direction (X-axis direction) as a reference. In the present embodiment, the gap G is configured using the Y-axis direction as a reference. A configuration of the gap G will be described later in detail.

Any electrically conductive material such as a metal material, e.g., copper or aluminum, may be used as a material for the loop-shaped conductor 20.

In the present embodiment, the X-axis direction corresponds to an embodiment of a first direction.

The Y-axis direction corresponds to an embodiment of a predetermined second direction orthogonal to the first direction.

The first short side 24a and the second short side 24b correspond to an embodiment of a first edge portion and the second edge portion that are opposite to each other along the second direction and constitute the gap.

The length of the loop-shaped conductor 20 (loop length: length from the first short side 24a to the second short side 24b) is, for example, designed to be equal to or smaller than ½ of the maximum wavelength of electromagnetic waves included in the frequency bandwidth used for the wireless communication using the antenna 8.

For example, in a case where Bluetooth (registered trademark) communication is performed, the loop length is designed to be equal to or smaller than ½ of the maximum wavelength of electromagnetic waves included in the Bluetooth (registered trademark) bandwidth (a frequency bandwidth of from 2.40 GHz to 2.48 GHz). As a matter of course, the present technology can also be applied in a case where wireless communication other than the Bluetooth (registered trademark) communication is performed.

Otherwise, in a case where the wavelength of electromagnetic waves used for the wireless communication using the antenna 8 is determined, the loop length of the loop-shaped conductor 20 may be designed with a length equal to or smaller than the wavelength of electromagnetic waves. Moreover, the loop length of the loop-shaped conductor 20 may be designed with a length equal to or smaller than a wavelength at the center frequency of the frequency bandwidth used for the wireless communication using the antenna 8.

It should be noted that a length equal to or smaller than the wavelength of electromagnetic waves used for the wireless communication and a length equal to or smaller than the wavelength at the center frequency of the frequency bandwidth used for the wireless communication can also be the length equal to or smaller than ½ of the maximum wavelength of electromagnetic waves included in the frequency bandwidth used for the wireless communication.

The structure 21 is electrically connected to the loop-shaped conductor 20.

That is, for the structure 21, an electrically conductive portion (the illustration is omitted) made of an electrically conductive material is configured, and the electrically conductive portion and the loop-shaped conductor 20 are electrically connected to each other.

For example, a circuit board or a system in package (SiP) is arranged as the structure 21. Then, for example, various circuits such as a ground, a communication circuit, and a matching circuit, wires and elements that constitute the circuits, and the like are implemented as the electrically conductive portion. Alternatively, a flat plate member made of an electrically conductive material may be used as the structure 21 and may be electrically connected to the loop-shaped conductor 20.

Any configuration electrically connected to the loop-shaped conductor 20 may be employed as the structure 21. For example, a flexible printed circuit (FPC) and the like may constitute the structure 21.

As shown in FIG. 7, in the present embodiment, the structure 21 is constituted by a flat-plate shape with an upper surface 31a, a lower surface 31b, and a side surface 31c. The upper surface 31a and the lower surface 31b are main surfaces of the structure 21.

The structure 21 is arranged orthogonally to the Y-axis direction. That is, the structure 21 is arranged such that the upper surface 31a and the lower surface 31b are orthogonal to the Y-axis direction.

As the antenna 8 is viewed from the front side along the center axis direction (X-axis direction), the structure 21 is arranged at an upper position on the loop plane. That is, the structure 21 is arranged at the upper position in a space on the inner peripheral side of the loop-shaped conductor 20.

Therefore, the upper surface 31a of the structure 21 and the upper portion 26 of the loop-shaped conductor 20 approach each other, and the lower surface 31b of the structure 21 and the lower side portion 27 of the loop-shaped conductor 20 are sufficiently spaced from each other. Moreover, the upper surface 31a and the lower surface 31b of the structure 21 and the upper portion 26 and the lower side portion 27 of the loop-shaped conductor 20 are arranged in parallel with each other.

The first wiring portion 22 electrically connects the structure 21 and the loop-shaped conductor 20 to each other.

One end portion of the first wiring portion 22 is connected to the electrically conductive portion configured in the structure 21. The other end portion of the first wiring portion 22 is connected to the loop-shaped conductor 20. In the present embodiment, the first wiring portion 22 is connected to the upper position of the left side portion 28 of the loop-shaped conductor 20.

A connection position of the first wiring portion 22 with respect to the loop-shaped conductor 20 is not limited, and may be arbitrarily set.

Any electrically conductive material such as a metal material, e.g., copper or aluminum, may be used as a material for the first wiring portion 22.

The second wiring portion 23 is connected to the loop-shaped conductor 20. In the present embodiment, the second wiring portion 23 is connected to a right position of the upper portion 26 of the loop-shaped conductor 20.

In the present embodiment, the loop-shaped conductor 20 is supplied with high-frequency AC power via the second wiring portion 23.

The connection position of a second wiring portion 22 with respect to the loop-shaped conductor 20 is not limited, and may be arbitrarily set.

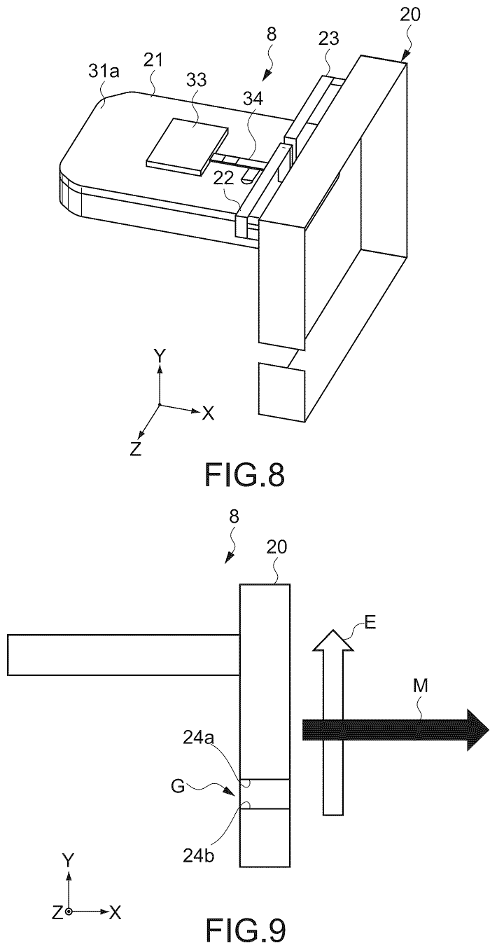

FIG. 8 is a schematic view showing a specific configuration example of the structure 21.

In the example shown in FIG. 8, a circuit board is used as the structure 21. Then, a communication circuit 33, a matching circuit 34, and a ground (the illustration is omitted) are configured on the upper surface 31a of the structure 21.

The communication circuit 33 and the matching circuit 34 are connected to the second wiring portion 23 and functions as an element included in the wireless communication unit 5 shown in FIG. 1. Moreover, the communication circuit 33 and the matching circuit 34 also function as the AC power source 11 shown in FIG. 7.

At the time of sending data, AC power is supplied to the loop-shaped conductor 20 via the communication circuit 33 and the matching circuit 34 and wireless signals (electromagnetic waves) are radiated.

At the time of receiving data, electrical signals corresponding to wireless signals (electromagnetic waves) received by the loop-shaped conductor 20 are output to the communication circuit 33 via the matching circuit 34. Then, data is acquired by the communication circuit 33 on the basis of the electrical signals.

The ground is connected to the first wiring portion 22 and is electrically connected to the loop-shaped conductor 20.

Specific configurations of the communication circuit 33, the matching circuit 34, and the ground are not limited, and may be arbitrarily designed.

In the present embodiment, via the matching circuit 34, the communication circuit 33 functions as a communication circuit unit that controls wireless communication by the antenna 8.

In the example shown in FIG. 8, the communication circuit unit is configured in the structure 21. Moreover, the communication circuit unit and the loop-shaped conductor 20 are electrically connected to the second wiring portion 23.

### Configuration of Gap

FIG. 9 is a side view as the antenna 8 is viewed from the left side along the Z-axis direction.

At the time of driving the antenna 8, the X-axis direction is the direction of the magnetic current source M generated by the loop-shaped conductor 20. Conversely, the X-axis direction is defined to be the direction of the magnetic current source M generated by the loop-shaped conductor 20 and the loop-shaped conductor 20 is configured using the X-axis direction as a reference.

As shown in FIG. 9, the antenna 8 according to the present embodiment is configured such that the Y-axis direction is the direction of the electric current source E generated by the loop-shaped conductor 20 at the time of driving the antenna 8. That is, the antenna 8 is configured such that the direction of the magnetic current source M and the direction of the electric current source E intersect with each other.

The configuration in which the direction of the magnetic current source M and the direction of the electric current source E intersect with each other (hereinafter, referred to as an EM intersecting configuration) can be achieved by designing a configuration of the gap G of the loop-shaped conductor 20 as appropriate.

For example, the predetermined direction orthogonal to the direction of the magnetic current source M is defined as the direction of the electric current source E. The gap G is configured using the defined direction as a reference. That is, the gap G is configured such that the defined direction is the direction of the electric current source E generated by the loop-shaped conductor 20. Accordingly, the EM intersecting configuration can be achieved.

In the present embodiment, the gap G is configured such that the Y-axis direction is the direction of the electric current source E generated by the loop-shaped conductor 20, and the EM intersecting configuration is achieved.

For example, by adjusting the position of the gap G in the loop-shaped conductor 20, the direction of the gap G (direction in which the first short side 24a and the second short side 24b that constitute the gap G are opposite to each other), and the like, the configuration (i.e., the EM intersecting configuration) in which the Y-axis direction is the direction of the electric current source E can be achieved.

As shown in FIGS. 7 and 9, in the present embodiment, the gap G is configured at a lower portion of the left side portion 28 of the loop-shaped conductor 20. Specifically, the gap G is configured such that the first short side 24a and the second short side 24b that extend along the X-axis direction are opposite to each other along the Y-axis direction.

Accordingly, the EM intersecting configuration can be achieved. An electric field generated along the Y-axis direction which is the direction of the gap G in the gap G can be considered to largely contribute to it.

It should be noted that the configuration in which the Y-axis direction is the direction of the electric current source E is not limited to a case where the direction of the gap G is parallel to the Y-axis direction. Also in a case where the direction of the gap G intersects with the Y-axis direction within a predetermined range, the EM intersecting configuration can be achieved.

It is sufficient that the position of the gap G, the direction of the gap, and the like are designed as appropriate so as to achieve the EM intersecting configuration on the basis of, for example, the shape of the loop as viewed along the center axis direction, the loop length of the loop-shaped conductor 20, the extending direction of two short sides that constitute the gap G, and the width of the loop-shaped conductor 20 (the size in the X-axis direction).

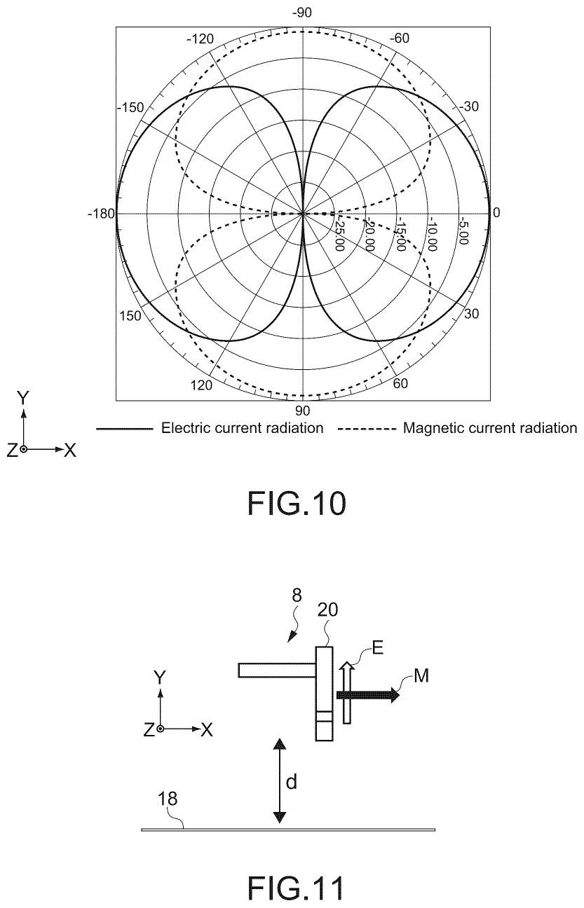

FIG. 10 is a graph showing a radiation pattern (radiation directivity) of electromagnetic waves.

FIG. 10 shows respective radiation patterns of the electric current radiation (solid line) and the magnetic current radiation (broken line) on the plane (XY-plane) including the X-axis direction and the Y-axis direction.

It should be noted that the center of the graph corresponds to the center of the loop plane on the inner peripheral side of the loop-shaped conductor 20. A direction from “−180” to “0” corresponds to the X-axis direction and a direction from “90” to “−90” corresponds to the Y-axis direction.

As shown in FIG. 10, the radiation pattern of the electric current radiation on the XY-plane is a figure 8-shaped radiation pattern along the X-axis direction. It should be noted that as viewed in an XYZ-space, the radiation pattern of the electric current radiation is a donut-shaped radiation pattern having the Y-axis direction as the center axis direction.

The pattern of the magnetic current radiation on the XY-plane is a figure 8-shaped radiation pattern along the Y-axis direction. It should be noted that as viewed in the XYZ-space, the radiation pattern of the magnetic current radiation is a donut-shaped radiation pattern having the X-axis direction as the center axis direction.

In this manner, in the antenna 8 according to the present embodiment, the radiation pattern by the electric current source E and the radiation pattern by the magnetic current source M are configured to intersect with each other. The radiation pattern by the electric current source E and the radiation pattern by the magnetic current source M are radiation patterns different in polarization from each other.

The radiation pattern of the electric current radiation (solid line) and the radiation pattern of the magnetic current radiation (broken line) shown in FIG. 10 correspond to an embodiment of radiation patterns of electromagnetic waves on a plane including the first direction and the second direction.

The radiation pattern of the magnetic current radiation (broken line) is an embodiment of a first radiation pattern by a magnetic current source along the first direction.

The radiation pattern of the electric current radiation (solid line) is an embodiment of a second radiation pattern by an electric current source along the second direction.

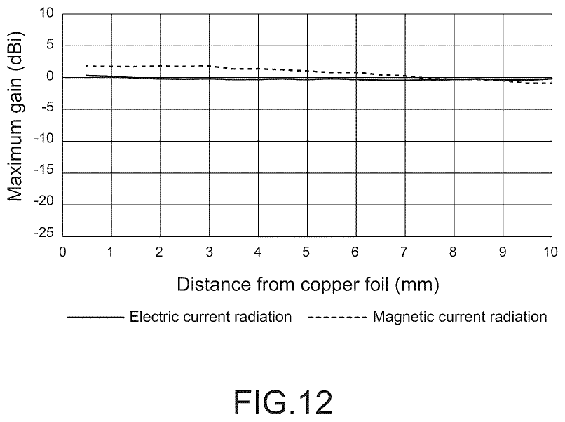

FIGS. 11 and 12 are diagrams for describing simulation results regarding a case where the copper foil has approached the antenna 8 according to the present embodiment.

As shown in FIG. 11, the antenna 8 is installed such that the direction (X-axis direction) of the magnetic current source M is parallel to the copper foil 18 and the direction (Y-axis direction) of the electric current source E is perpendicular to the copper foil 18. Moreover, the maximum gain is calculated by simulation while changing the distance d between the copper foil 18 and the antenna 8.

FIG. 12 plots the maximum gain of the electric current radiation (radiation by the electric current source E) and the maximum gain of the magnetic current radiation (radiation by the magnetic current source M) of the antenna 8 in a case where the distance d is reduced from 10 mm.

The electric current source E configured by the loop-shaped conductor 20 is configured in a direction perpendicular to the copper foil 18. That is, the relation between the electric current source E and the copper foil 18 is similar to that shown in A of FIG. 3. Thus, as shown in FIG. 12, even if the antenna 8 is made to approach the copper foil, the maximum gain of the electric current radiation is maintained without decreasing (it slightly increases along with approaching).

The magnetic current source M configured by the loop-shaped conductor 20 is configured in a direction parallel to the copper foil 18. That is, the relation between the magnetic current source M and the copper foil 18 is similar to that shown in D of FIG. 3. Thus, as shown in FIG. 12, even if the antenna 8 is made to approach the copper foil 18, the maximum gain of the magnetic current radiation is maintained without decreasing (it slightly increases along with approaching).

That is, in the antenna 8 according to the present embodiment, the direction of the electric current source E and the direction of the magnetic current source M intersect with each other, and therefore even in a case where it has approached the human body or metal, both the electric current source E (electric current radiation) and the magnetic current source M (magnetic current radiation) are not weakened and a high maximum gain is exhibited. Thus, very high communication performance is exhibited.

For example, the antenna 8 is installed with respect to an object constituted by any conductor or any dielectric. In this case, the antenna 8 is configured such that the direction (Y-axis direction) of the electric current source E is along the direction perpendicular to the object. This configuration is also a configuration in which the direction (X-axis direction) of the magnetic current source M is along the direction parallel to the object.

Accordingly, the state shown in A of FIG. 3 is provided with respect to the electric current radiation and the state shown in D of FIG. 3 is provided with respect to the magnetic current radiation. That is, a state in which electromagnetic waves enhance each other with respect to both the electric current radiation and the magnetic current radiation, and the wireless communication can be executed with high communication performance.

It should be noted that a configuration in which a direction A is along a direction B is not limited only to a case where the direction A is arranged in parallel with the direction B. It also includes a case where the direction A is arranged obliquely to the direction B within a predetermined range. In the present embodiment, in such a range that high communication performance is exhibited, the direction (Y-axis direction) of the electric current source E may be arranged along the direction perpendicular to the object.

For example, within a range of an angle of intersection of 0 degrees to 10 degrees, the direction (Y-axis direction) of the electric current source E is arranged along the direction perpendicular to the object. Accordingly, high communication performance can be exhibited. As a matter of course, the predetermined range varies depending on a surrounding environment and other metal parts.

### Positional Relation Between Loop-Shaped Conductor 20 and Structure 21

As shown in FIG. 7 and the like, the structure 21 is arranged orthogonally to the Y-axis direction. That is, the upper surface 31a and the lower surface 31b which are the main surfaces are arranged orthogonally to the Y-axis direction.

Therefore, the main surfaces of the structure 21 are orthogonal to the electric current source E constituted by the loop-shaped conductor 20. Moreover, the main surfaces of the structure 21 are parallel to the magnetic current source M configured by the loop-shaped conductor 20. Thus, the relation between the structure 21 and the electric current source E is the state shown in A of FIG. 3 and the relation between the structure 21 and the magnetic current source M is the state shown in D of FIG. 3.

Therefore, the electric current source E and the magnetic current source M are weakened by the structure 21, and high communication performance is exhibited. In this manner, in the antenna 8 according to the present embodiment, the positional relation between the loop-shaped conductor 20 and the structure 21 is also a significant feature.

It should be noted that such a configuration that the direction (Y-axis direction) of the electric current source E is along the direction perpendicular to the object can also be said to be a configuration in which the structure 21 (main surfaces) is parallel to the object.

### Application to TWS

A case where the antenna 8 shown in FIG. 7 and the like is mounted on the TWS 1 will be described.

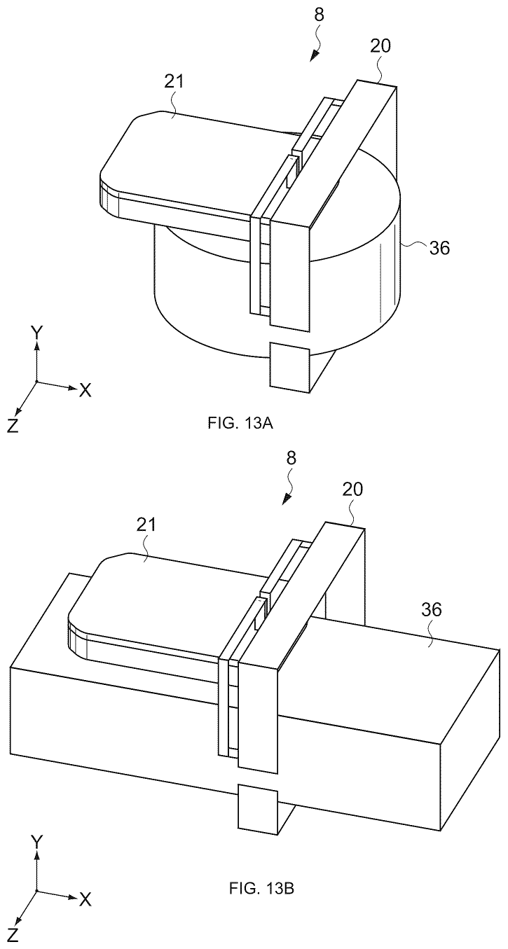

FIG. 13 is a view for describing assembling with other parts.

The antenna 8 according to the present embodiment enables the space (loop plane) on the inner peripheral side of the loop-shaped conductor 20 to be efficiently used as a space.

For example, as shown in A and B of FIG. 13, a variety of parts 36 can be arranged in the space on the inner peripheral side of the loop-shaped conductor 20.

In the example shown in A and B of FIG. 13, a lower space of the structure 21 is efficiently used in the space on the inner peripheral side of the loop-shaped conductor 20.

In the example shown in A of FIG. 13, a columnar part 36 is arranged on the lower side of the structure 21 in the space on the inner peripheral side of the loop-shaped conductor 20.

In the example shown in A of FIG. 13, a rectangular parallelepiped part 36 is arranged on the lower side of the structure 21 in the space on the inner peripheral side of the loop-shaped conductor 20.

In this manner, parts having various shapes can be arranged in the space on the inner peripheral side of the loop-shaped conductor 20.

For example, any parts such as batteries, acoustic parts, and metal parts can be arranged as the parts 36.

Any parts such as the parts constituting the TWS 1, the parts included in the antenna 8, and the parts constituting a functional portion different from the antenna 8 in the TWS 1 can be arranged.

By efficiently using the space on the inner peripheral side of the loop-shaped conductor 20 in this manner, downsizing of the TWS 1 can be achieved.

Moreover, communication performance can also be improved by setting the positions where the parts 36 are arranged and the like as appropriate. For example, considering the relation between the electric current source E and the magnetic current source M generated by the loop-shaped conductor 20, the parts 36 are arranged to enter the state shown in A and D of FIG. 3. Accordingly, it is possible to achieve an improvement in the communication performance.

Moreover, a part made of magnetic material is arranged as one of the parts 36. Accordingly, it is possible to achieve an improvement in the communication performance. For example, as a part aiming at improving the communication performance, a part 36 made of magnetic material may be arranged.

FIGS. 14 and 15 are schematic views showing the orientation of the antenna 8 in the TWS 1.

FIG. 15 shows a state in which the TWS 1 is worn on the ear 4. The ear piece 3 of the TWS 1 is inserted into an external acoustic pore 38 of the ear 2.

It should be noted that in FIG. 15, the reference sign of the external acoustic pore 38 is schematically shown at a portion of the TWS 1 which is close to the ear 4.

The antenna 8 is configured inside the TWS 1 with a portion where the external acoustic pore 38 (which can also be said to be the external acoustic pore 38 and the surrounding portion) is formed as an object constituted by a lossy dielectric that approaches the antenna 8. That is, the antenna 8 is configured inside the TWS 1 so as to exhibit high communication performance also when the portion where the external acoustic pore 38 is formed has approached the antenna 8.

Specifically, the antenna 8 is configured such that the direction (Y-axis direction) of the electric current source E is a direction perpendicular to the external acoustic pore 38 when the TWS 1 is worn on the ear 4. In other words, the antenna 8 is configured such that the direction (X-axis direction) of the magnetic current source M is along a direction parallel to the external acoustic pore 38.

The direction along the direction perpendicular to the external acoustic pore 38 includes not only the direction perpendicular to the external acoustic pore 38, but also the direction intersecting with the external acoustic pore 38 within a predetermined range. Moreover, the direction along the direction parallel to the external acoustic pore 38 includes not only the direction parallel to the external acoustic pore, but also the direction intersecting with the external acoustic pore within a predetermined range.

When the TWS 1 is worn on the ear 4, the relation between the electric current source E constituted by the loop-shaped conductor 20 of the antenna 8 and the portion where the external acoustic pore 38 is formed is similar to that shown in A of FIG. 3. Moreover, the relation between the magnetic current source M constituted by the loop-shaped conductor 20 and the portion where the external acoustic pore 38 is formed is similar to that shown in D of FIG. 3.

Therefore, also when the antenna 8 configured inside the TWS 1 has approached the portion where the external acoustic pore 38 is formed, it is possible to exhibit high communication performance. Therefore, it is possible to configure the antenna 8 at a position adjacent to the external acoustic pore 38, and therefore downsizing of the TWS 1 can be achieved.

It should be noted that even if the direction of the electric current source E and the direction of the magnetic current source M are set as described above using “the direction perpendicular to the external acoustic pore 38” to be “an opening direction of the external acoustic pore 38”, “a direction perpendicular to a cheek on a side where the ear 4 is located”, or “a direction in which the TWS 1 is worn the external acoustic pore 38”, similar effects are exhibited.

Moreover, an effective technical matter regarding the positional relation between an auricle 39 of the ear 4 and the gap G was able to be devised as a result of further considerations.

Specifically, the gap G is configured at a portion of the loop-shaped conductor 20 which is adjacent to the auricle 39 when the TWS 1 is worn on the ear 4. That is, in addition to the point that it is a configuration that can achieve the EM intersecting configuration, the gap G is configured at a portion further adjacent to the auricle 39. Accordingly, it is possible to improve the communication performance.

This technical matter is a technical matter newly found as a configuration enabling an improvement in the communication performance as a result of simulation.

It can be considered that this technical matter is provided by an effect of arranging a portion through which electric current actually flows (i.e., a portion where no gap G is formed) to a position farther away from the human body than a portion (gap G) where electric charges are accumulated.

### Variations of Loop-Like Conductor, First Wiring Portion, and Second Wiring Portion

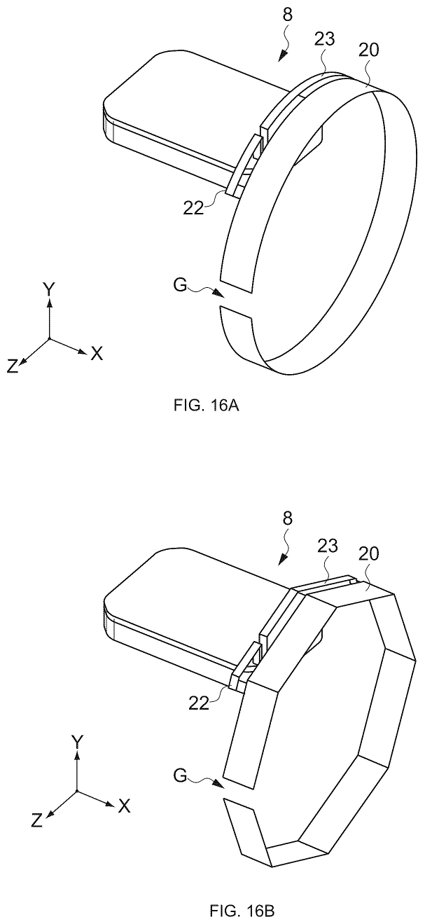

Referring to FIGS. 16 to 20, variation examples of the loop-shaped conductor 20, the first wiring portion 22, and the second wiring portion 23 will be described. Various configurations can be employed as long as the above-mentioned EM intersecting configuration can be achieved.

It should be noted that the antenna 8 with the EM intersecting configuration achieved can also be called EM intersecting antenna.

In the example shown in A of FIG. 16, the loop-shaped conductor 20 is configured such that the shape of the loop is circular as viewed from the direction (X-axis direction) of the magnetic current source M. The gap G is configured such that the direction of the gap G is parallel to the Y-axis direction at a leftmost portion of the loop-shaped conductor 20.

The first wiring portion 22 and the second wiring portion 23 are also configured in parallel with the loop-shaped conductor 20 so as to conform to the shape of the loop.

In the example shown in B of FIG. 16, the loop-shaped conductor 20 may be configured such that the shape of the loop is a polygon as viewed from the direction (X-axis direction) of the magnetic current source M. In the example shown in B of FIG. 16, the loop-shaped conductor 20 is configured such that the shape of the loop is an octagon. The gap G is configured such that the direction of the gap G is parallel to the Y-axis direction at the leftmost vertex.

The first wiring portion 22 and the second wiring portion 23 are also configured in parallel with the loop-shaped conductor 20 so as to conform to the shape of the loop.

In this manner, the shape of the loop is not limited, and may be arbitrarily designed. As a matter of course, a polygonal shape other than the octagon shape may be employed.

By designing the area surrounding the loop (the area of the loop plane) to increase inside the TWS 1, it is possible to improve the communication performance.

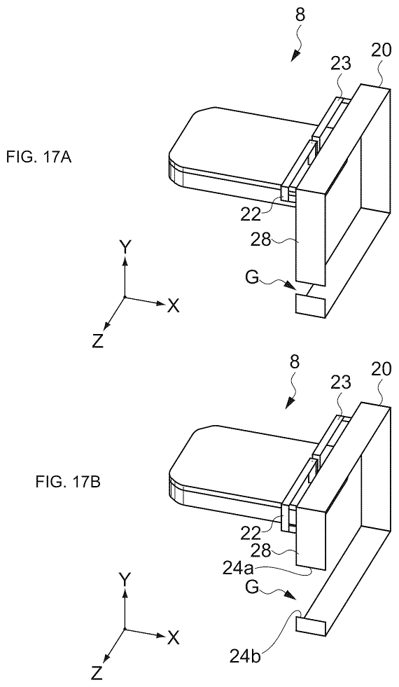

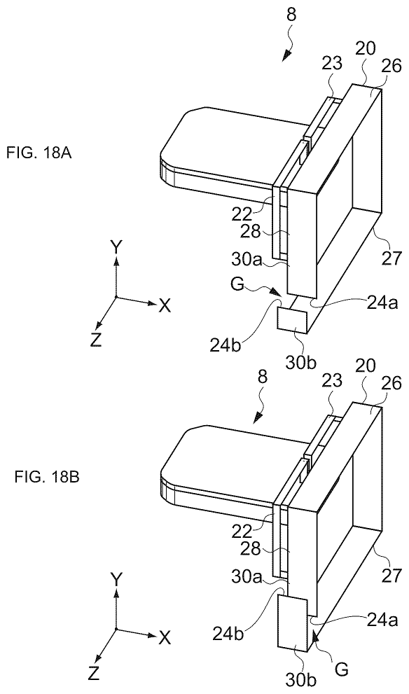

In the example shown in A of FIG. 17, the position of the gap G differs as compared to the configuration shown in FIG. 7. In the example shown in A of FIG. 17, the gap G is formed on a further lower side in the left side portion 28.

In the example shown in B of FIG. 17, the width of the gap G (the distance between the first short side 24a and the second short side 24b) is designed to be much larger than that of the configuration shown in FIG. 7.

In this manner, the position of the gap G and the width of the gap G can also be arbitrarily designed. For example, by adjusting the width of the gap G, the resonant frequency can be adjusted.

In the example shown in A of FIG. 18, the length of the lower side portion 27 is set to be longer than the upper portion 26. In addition, the left end portion of the lower side portion 27 is located on the left side with respect to the left side portion 28. That is, the left end portion of the lower side portion 27 projects leftwards.

Therefore, the lower portion 30b of the left side portion 28 is positioned on the left side with respect to the upper portion 30a of the left side portion 28. Moreover, the second short side 24b constituting the gap G is positioned on the left side with respect to the first short side 24a.

As a result, the direction of the gap G (the direction in which the first short side 24a and the second short side 24b are opposite to each other) is a direction intersecting with the Y-axis direction.

In the example shown in B of FIG. 18, the length of the lower portion 30b of the left side portion 28 is designed to be larger and the second short side 24b is arranged above the first short side 24a. Thus, as the left side portion 28 of the loop-shaped conductor 20 is viewed from the left side, the upper portion 30a and the lower portion 30b are configured to overlap each other and a configuration in which the first short side 24a cannot be seen is provided.

As a result, the direction of the gap G (the direction in which the first short side 24a and the second short side 24b are opposite to each other) is a direction intersecting with the Y-axis direction.

As shown in A and B of FIG. 18, also in a case where the direction of the gap G is oblique to the Y-axis direction, the EM intersecting configuration can be achieved. For example, in a case where the direction of the gap G is exploded into vector components in the respective XYZ-directions, principally in a case where more vector components in the Y-axis direction are included, the EM intersecting configuration can be easily achieved.

As shown in A and B of FIG. 18, also by adjusting the length of the lower side portion 27, the length of the lower portion 30b of the left side portion 28, and the like, the width of the gap G can be adjusted, and the resonant frequency can be adjusted.

For example, a mechanism capable of adjusting the width of the gap G may be configured inside the antenna 8. Then, the width of the gap G may be adjusted automatically or in accordance with an instruction made by a user or the like. Accordingly, it is possible to adjust the resonant frequency and it is possible to overcome individual differences between people who use a true wireless stereo.

It should be noted that any configuration may be employed as the mechanism capable of adjusting the width of the gap G. A gap width adjustment mechanism can be achieved by, for example, a configuration in which actuators such as a piezoelectric element and a motor are used.

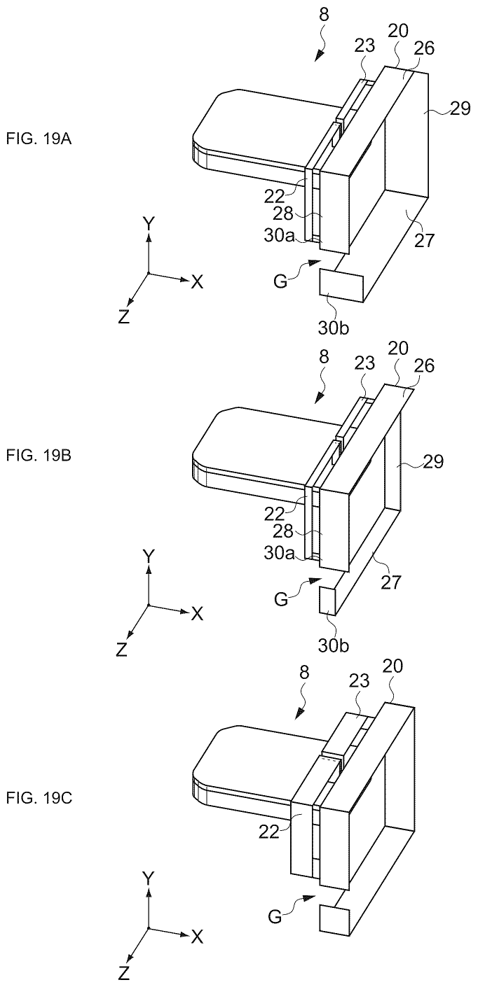

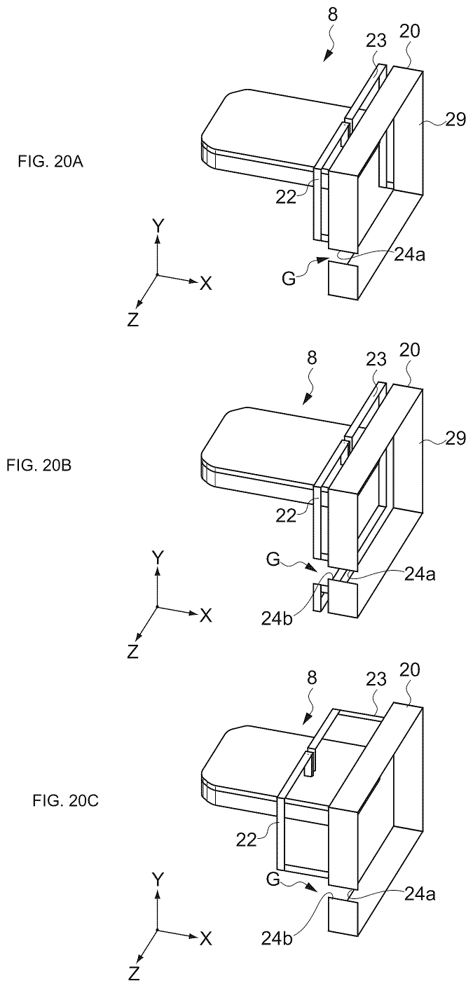

In the example shown in A of FIG. 19, the widths of the upper portion 26 of the loop-shaped conductor 20 and the upper portion 30a of the left side portion 28 are designed to be relatively small (narrow). Meanwhile, the widths of the right side portion 29, the lower side portion 27, and the lower portion 30b of the left side portion 28 of the loop-shaped conductor 20 are designed to be relatively large (wide).

In the example shown in B of FIG. 19, the widths of the upper portion 26 of the loop-shaped conductor 20 and the upper portion 30a of the left side portion 28 are designed to be relatively large (wide). Meanwhile, the widths of the right side portion 29, the lower side portion 27, and the lower portion 30b of the left side portion 28 of the loop-shaped conductor 20 are designed to be relatively small (narrow).

As shown in A and B of FIG. 19, the width of the loop-shaped conductor 20 may be adjusted partially as appropriate.

By designing the width of the loop-shaped conductor 20 to be large inside the TWS 1, it is possible to improve the communication performance.

Meanwhile, by designing the width of the loop-shaped conductor 20 as appropriate as illustrated in A and B of FIG. 19, a flexible design can be provided regarding installation of the antenna 8 in the TWS 1. That is, the antenna 8 with high performance can be configured inside the TWS 1 with small capacity. It is very advantageous for downsizing of the TWS 1.

It should be noted that a linear conductor such as a wire may be used as the loop-shaped conductor 20 as long as the EM intersecting configuration can be achieved. Otherwise, any configuration may be employed as the loop-shaped conductor.

In the example shown in C of FIG. 19, the width of the first wiring portion 22 and the width of the second wiring portion 23 are designed to be larger (wider).

In the example shown in A to C of FIGS. 20, the length of the first wiring portion 22 and the length of the second wiring portion 23 are adjusted as appropriate.

In the example shown in A of FIG. 20, the first wiring portion 22 extends to the vicinity of the first short side 24a along the loop-shaped conductor 20. Accordingly, the first wiring portion 22 is designed to be longer (it should be noted that this configuration is employed also in FIGS. 18 and 19).

The second wiring portion 23 extends to a lower portion of the right side portion 29 along the loop-shaped conductor 20. Accordingly, the second wiring portion 23 is prolonged.

In the example shown in B of FIG. 20, the second wiring portion 23 extends to the vicinity of the second short side 24b along the loop-shaped conductor 20. Accordingly, the second wiring portion 23 can be further designed.

In the example shown in C of FIG. 20, the position of the end portion on a side opposite to the side of the first wiring portion 22 which is connected to the loop-shaped conductor 20 is adjusted. That is, the connection position between the first wiring portion 22 and the structure 21 is adjusted. Accordingly, the first wiring portion 22 can be designed to be longer.

Also regarding the second wiring portion 23, the position of the end portion on a side opposite to the side connected to the loop-shaped conductor 20 is adjusted. Accordingly, the second wiring portion 23 can be designed to be longer.

As shown in C of FIG. 19 and A to C of FIG. 20, the widths and lengths of the first wiring portion 22 and the second wiring portion 23 may be adjusted as appropriate. Moreover, the wiring patterns or the like of the first wiring portion 22 and the second wiring portion 23 can also be adjusted as appropriate.

Impedance can be adjusted by adjusting the widths, the lengths, the wiring patterns, and the like of the first wiring portion 22 and the second wiring portion 23. That is, impedance matching can be performed by adjusting the wiring patterns and the like.

It should be noted that optimal wiring patterns vary depending on a surrounding environment and arrangement of other metal parts, and the like. Thus, it is sufficient that the widths, the lengths, the wiring patterns, and the like of the first wiring portion 22 and the second wiring portion 23 are adjusted as appropriate on the basis of the surrounding environment or the like.

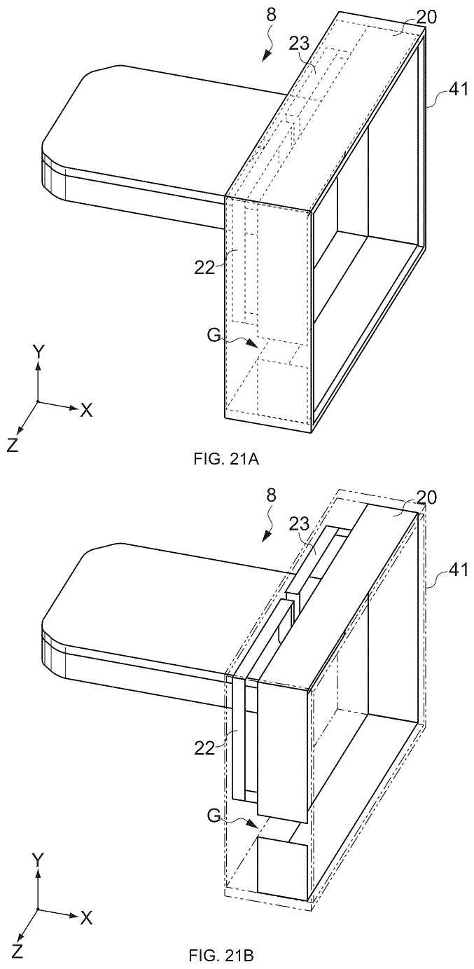

A and B of FIG. 21 are schematic views showing a configuration example of the antenna 8 in a case where a flexible printed circuit (FPC) is used.

As shown in FIG. 21, a flexible printed circuit (FPC) 41 on which the loop-shaped conductor 20 is formed may be deformed in a loop shape so as to surround the direction (X-axis direction) of the magnetic current source M.

In the example shown in FIG. 21, the first wiring portion 22 and the second wiring portion 23 are also formed in the FPC 41. By using the FPC 41, the antenna 8 can be easily manufactured.

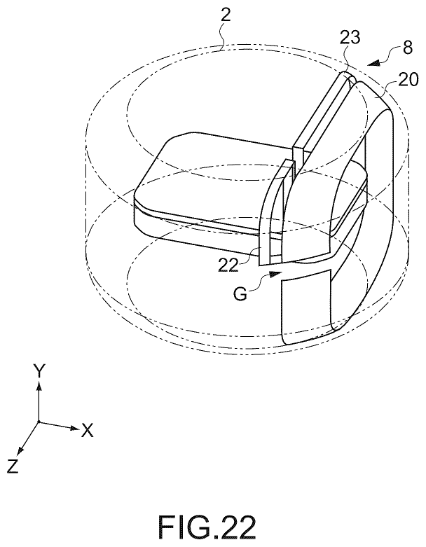

FIG. 22 is a schematic view showing an example in a case where the loop-shaped conductor 20 is configured by laser direct structuring (LDS).

As shown in FIG. 22, the loop-shaped conductor 20 may be configured inside the casing portion 2 in which the antenna 8 is arranged by the LDS.

In the example shown in FIG. 22, the first wiring portion 22 and the second wiring portion 23 are also configured inside the casing portion 2 by the LDS. The use of the LDS is advantageous for downsizing the apparatus.

Hereinabove, in the TWS 1 and the antenna 8 according to the present embodiment, the loop-shaped conductor 20 having a loop-shaped configuration surrounding the X-axis direction and having the gap G configured using the Y-axis direction as a reference is used. Moreover, the structure 21 is arranged to the loop-shaped conductor 20 so as to be orthogonal to the Y-axis direction. Accordingly, downsizing and a performance improvement can be achieved.

Along with prevalence of the true wireless stereo, needs for its downsizing and performance improvement have increased. Meanwhile, mounting the antenna for the Bluetooth (registered trademark) communication or the like has increased the amount of projection from the ear for the antenna to sufficiently exhibit the communication performance, and therefore it has been difficult to achieve downsizing.

Although the antenna mounted on the true wireless stereo can be the NMHA 14 as illustrated in FIG. 4, the electric current source E (electric current radiation) or the magnetic current source M (magnetic current radiation) is significantly attenuated by approaching the human body or metal as described above with reference to FIGS. 5 and 6. Therefore, it has been difficult to exhibit sufficient communication performance.

As shown in FIG. 7 and the like, in the antenna 8 according to the present technology, the conductor pattern in a loop shape partially having the gap G is employed and used as the loop-shaped conductor 20.

Accordingly, the EM intersecting configuration is achieved. Therefore, when a metal or human body has approached radiation from both the electric current source E and the magnetic current source M, the gain attenuation can be sufficiently prevented, and the gain enhancement can also be obtained depending on a configuration.

Accordingly, in a case where the present technology is applied to the electronic apparatus including the TWS 1, it is possible to achieve a reduction of a distance from the human body and a reduction of a clearance from a metal part, and it is very advantageous for downsizing the electronic apparatus. Moreover, it is possible to exhibit high communication performance.

### Other Embodiments

The present technology is not limited to the above-mentioned embodiments, and various other embodiments can be realized.

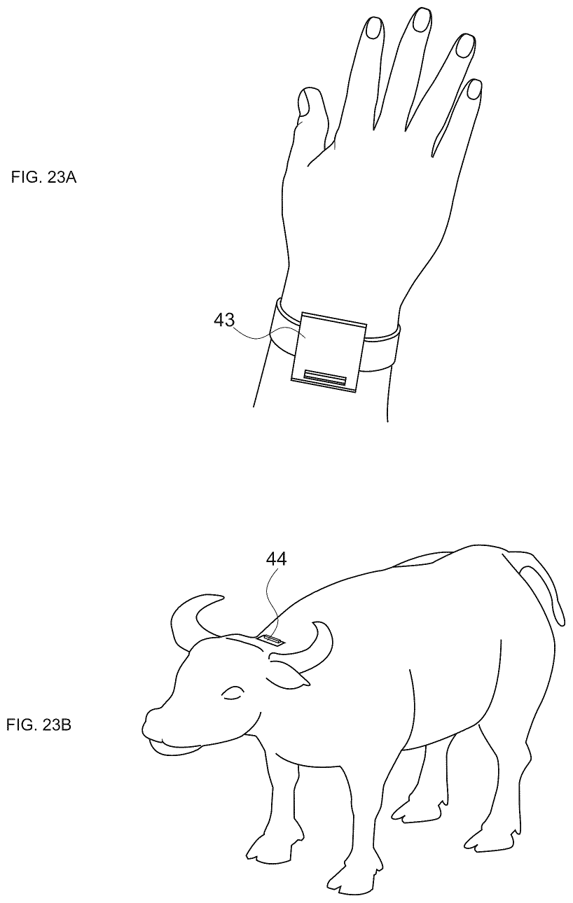

FIG. 23 is a schematic view for describing other application examples of the present technology.

The application of the present technology is not limited to the true wireless stereo, and the present technology can be applied to any wireless communication device in any other fields.

For example, as shown in A of FIG. 23, the antenna 8 according to the present technology can be applied to a wristband-type wearable device 43 used when it is worn on the wrist. In this case, the wearable device 43 shown in A of FIG. 23 functions as an embodiment of the electronic apparatus according to the present technology.

The antenna 8 is configured inside the wearable device 43 such that the direction of the electric current source E is perpendicular to an arm and the direction of the magnetic current source M is parallel to the arm. Accordingly, downsizing of the apparatus and a performance improvement in the wireless communication can be achieved.

For example, a loop shape which is relatively small in size in a direction perpendicular to the arm and is wide along a direction parallel to the arm may be employed for the loop-shaped conductor 20. Accordingly, downsizing of the apparatus can be further achieved.

Not limited to the wristband-type wearable device, the present technology can be applied to a wearable device in any form such as a headband-type (head-mounted-type) to be mounted on a head, a belt-type worn on a waist, or an anklet-type worn on an anklet.

As shown in B of FIG. 23, the present technology can be applied to an IoT sensor 44 worn on livestock such as a cattle. The use of the antenna according to the present technology enables downsizing of the apparatus and a performance improvement in the wireless communication to be achieved.

As a matter of course, the present technology can also be applied to IoT sensors to be mounted on animals other than the livestock, household electrical appliances, machines, robots, and the like.

Otherwise, the types of electronic apparatuses to which the present technology can be applied are not limited. The present technology can be applied to any electronic apparatuses including, for example, electronic apparatuses such as portable phones, smartphones, personal computers, game consoles, digital cameras, audio devices, TVs, projectors, car navigation systems, and GPS terminals, and various IoT apparatuses connected to the Internet or the like.

The respective configurations, the respective processing flows, and the like of the TWS, the antenna, the loop-shaped conductor, the first wiring portion, the second wiring portion, the structure, and the like, which have been described with reference to the respective drawings, are merely embodiments, and these can be arbitrarily modified without departing from the gist of the present technology. That is, any other configurations and algorithms and the like for carrying out the present technology may be employed.

In the present disclosure, for the sake of easy understanding of the description, wordings “substantially”, “almost”, “approximately”, etc. can be used as appropriate. Meanwhile, no clear differences are defined between a case where these wordings “substantially”, “almost”, “approximately”, etc. are used or a case where they are not used.

That is, in the present disclosure, it is assumed that the concepts that define the shape, the size, the positional relation, the state, and the like such as “center”, “middle”, “uniform”, “equal”, the “same”, “orthogonal”, “parallel”, “symmetric”, “extending”, “axial”, “columnar”, “cylindrical”, “ring-shaped”, and “annular” are concepts including “substantially center”, “substantially middle”, “substantially uniform”, “substantially equal”, “substantially the same”, “substantially orthogonal”, “substantially parallel”, “substantially symmetric”, “substantially extending”, “substantially axial”, “substantially columnar”, “substantially cylindrical”, “substantially ring-shaped”, “substantially annular”, and the like.

For example, states included in a predetermined range (e.g., ±10% range) using “completely center”, “completely middle”, “completely uniform”, “completely equal”, “completely the same”, “completely orthogonal”, “completely parallel”, “completely symmetric”, “completely extending”, “completely axial”, “completely columnar”, “completely cylindrical”, “completely ring-shaped”, “completely annular”, and the like as the bases are also included.

Therefore, also a case where no wordings “substantially”, “almost”, “approximately”, etc. are added can include concepts expressed by adding so-called “substantially”, “almost”, “approximately”, etc. On the contrary, states expressed with “substantially”, “almost”, “approximately”, etc. do not necessarily exclude complete states.

In the present disclosure, the comparative expressions, e.g., “larger than A” or “smaller than A” are expressions encompassing both a concept including a case where it is equal to A and a concept not including a case where it is equal to A. For example, “larger than A” is not limited to the case where not including “equal to A”, and also includes “A or more”. Moreover, “smaller than A” is not limited to “less than A”, and also includes “A or less”.

For carrying out the present technology, specific settings and the like only need to be employed as appropriate on the basis of the concepts included in “larger than A” and “smaller than A” so as to provide the above-mentioned effects.

At least two of the features according to the present technology, which have been described above, may be combined. That is, the various features described in the respective embodiments may be arbitrarily combined across the respective embodiments. Moreover, the above-mentioned various effects are merely exemplary and not limitative, and other effects may be provided.

It should be noted that the present technology can also take the following configurations.
(1) An antenna, including:
   a loop-shaped conductor that is configured in a loop shape surrounding a first direction and has a gap configured using a predetermined second direction orthogonal to the first direction as a reference; and
   a structure that is electrically connected to the loop-shaped conductor and arranged orthogonally to the second direction.
(2) The antenna according to (1), in which
   the first direction is set as a direction of a magnetic current source generated by the loop-shaped conductor, and
   the gap is configured such that the second direction is a direction of an electric current source generated by the loop-shaped conductor.
(3) The antenna according to (1) or (2), in which
   the loop-shaped conductor has a first edge portion and the second edge portion that are opposite to each other along the second direction and constitute the gap.
(4) The antenna according to any one of (1) to (3), in which
   a length of the loop-shaped conductor is equal to or smaller than ½ of a maximum wavelength of electromagnetic waves included in a frequency bandwidth used for wireless communication using the antenna.
(5) The antenna according to (4), in which
   the frequency bandwidth used for the communication is a frequency bandwidth of from 2.40 GHz to 2.48 GHz.
(6) The antenna according to any one of (1) to (5), which is configured such that the second direction is along a direction perpendicular to the object when the antenna is installed with respect to an object constituted by a conductor or a lossy dielectric.
(7) The antenna according to any one of (1) to (6), further including
   a flexible printed circuit (FPC) on which the loop-shaped conductor is formed.
(8) The antenna according to any one of (1) to (6), which is configured to be arranged inside a casing, in which
   the loop-shaped conductor is configured inside the casing by laser direct structuring (LDS).
(9) The antenna according to any one of (1) to (8), in which
   the structure has a flat-plate shape including a main surface, the main surface being arranged orthogonally to the second direction.
(10) The antenna according to (9), in which
   the structure is a circuit board or a system in package (SiP).
(11) The antenna according to any one of (1) to (10), further including:
   a communication circuit unit that controls wireless communication by the antenna;
   a first wiring portion that electrically connects the structure and the loop-shaped conductor to each other; and
   a second wiring portion that electrically connects the communication circuit unit and the loop-shaped conductor to each other.
(12) The antenna according to (11), in which
   the communication circuit unit is configured in the structure.
(13) The antenna according to any one of (1) to (12), in which
   a first radiation pattern by a magnetic current source along the first direction and a second radiation pattern by an electric current source along the second direction are configured as radiation patterns of electromagnetic waves on a plane including the first direction and the second direction.
(14) An electronic apparatus, including:
   an antenna including
      a loop-shaped conductor that is configured in a loop shape surrounding a first direction and has a gap configured using a predetermined second direction orthogonal to the first direction as a reference, and
      a structure that is electrically connected to the loop-shaped conductor and is arranged orthogonally to the second direction.
(15) The electronic apparatus according to (14), which is configured as a true wireless stereo.
(16) The electronic apparatus according to (15), which is configured to be worn on a human ear and is configured such that the second direction is along a direction perpendicular to an external acoustic pore when the electronic apparatus is worn on the ear.
(17) The electronic apparatus according to (16), which is configured to be worn on a human ear, in which
   the gap is configured in a portion of the loop-shaped conductor which is adjacent to an auricle when the electronic apparatus is worn on the ear.
(18) The electronic apparatus according to any one of (14) to (17), further including
   a part arranged in a space on an inner peripheral side of the loop-shaped conductor.
(19) The electronic apparatus according to (18), in which
   the part includes a magnetic material.

### REFERENCE SIGNS LIST

E electric current source
M magnetic current source
1 TWS
2 casing portion
38 external acoustic pore
20 loop-shaped conductor
21 structure
22 first wiring portion
23 second wiring portion
24a first short side
24b second short side
33 communication circuit
34 matching circuit
36 part
38 external acoustic pore
39 auricle
41 FPC
43 wearable device
44 IoT sensor

1. An antenna, comprising:
a loop-shaped conductor that is configured in a loop shape surrounding a first direction and has a gap configured using a predetermined second direction orthogonal to the first direction as a reference; and
a structure that is electrically connected to the loop-shaped conductor and arranged orthogonally to the second direction.

2. The antenna according to claim 1, wherein
the first direction is set as a direction of a magnetic current source generated by the loop-shaped conductor, and
the gap is configured such that the second direction is a direction of an electric current source generated by the loop-shaped conductor.

3. The antenna according to claim 1, wherein
the loop-shaped conductor has a first edge portion and the second edge portion that are opposite to each other along the second direction and constitute the gap.

4. The antenna according to claim 1, wherein
a length of the loop-shaped conductor is equal to or smaller than ½ of a maximum wavelength of electromagnetic waves included in a frequency bandwidth used for wireless communication using the antenna.

5. The antenna according to claim 4, wherein
the frequency bandwidth used for the communication is a frequency bandwidth of from 2.40 GHz to 2.48 GHz.

6. The antenna according to claim 1, which is configured such that the second direction is along a direction perpendicular to the object when the antenna is installed with respect to an object constituted by a conductor or a lossy dielectric.

7. The antenna according to claim 1, further comprising
a flexible printed circuit on which the loop-shaped conductor is formed.

8. The antenna according to claim 1, which is configured to be arranged inside a casing, wherein
the loop-shaped conductor is configured inside the casing by laser direct structuring.

9. The antenna according to claim 1, wherein
the structure has a flat-plate shape including a main surface, the main surface being arranged orthogonally to the second direction.

10. The antenna according to claim 9, wherein
the structure is a circuit board or a system in package.

11. The antenna according to claim 1, further comprising:
a communication circuit unit that controls wireless communication by the antenna;
a first wiring portion that electrically connects the structure and the loop-shaped conductor to each other; and
a second wiring portion that electrically connects the communication circuit unit and the loop-shaped conductor to each other.

12. The antenna according to claim 11, wherein
the communication circuit unit is configured in the structure.

13. The antenna according to claim 1, wherein
a first radiation pattern by a magnetic current source along the first direction and a second radiation pattern by an electric current source along the second direction are configured as radiation patterns of electromagnetic waves on a plane including the first direction and the second direction.

14. An electronic apparatus, comprising:
an antenna including
a loop-shaped conductor that is configured in a loop shape surrounding a first direction and has a gap configured using a predetermined second direction orthogonal to the first direction as a reference, and
a structure that is electrically connected to the loop-shaped conductor and is arranged orthogonally to the second direction.

15. The electronic apparatus according to claim 14, which is configured as a true wireless stereo.

16. The electronic apparatus according to claim 15, which is configured to be worn on a human ear and is configured such that the second direction is along a direction perpendicular to an external acoustic pore when the electronic apparatus is worn on the ear.

17. The electronic apparatus according to claim 16, which is configured to be worn on a human ear, wherein
the gap is configured in a portion of the loop-shaped conductor which is adjacent to an auricle when the electronic apparatus is worn on the ear.

18. The electronic apparatus according to claim 14, further comprising
a part arranged in a space on an inner peripheral side of the loop-shaped conductor.

19. The electronic apparatus according to claim 18, wherein
the part comprises a magnetic material.
